(19) United States
(12) Patent Application Publication
(10) Pub. No.: US 2017/0101302 A1
(43) Pub. Date: Apr. 13, 2017

(54) DETERMINING AN INVENTORY USING POSITIONAL AND NON-POSITIONAL AWARENESS

(71) Applicant: THE COCA-COLA COMPANY, Atlanta, GA (US)

(72) Inventors: Daniel S. Quartarone, Stone Mountain, GA (US); Benjamin John Kingston, Suwanee, GA (US); David R. Newman, Atlanta, GA (US)

(73) Assignee: THE COCA-COLA COMPANY, Atlanta, GA (US)

(21) Appl. No.: 15/127,807

(22) PCT Filed: Mar. 24, 2015
(86) PCT No.: PCT/US2015/022253

§ 371 Date: Sep. 21, 2016

Related U.S. Application Data
(60) Provisional application No. 61/971,116, filed on Mar. 27, 2014.

(51) Int. Cl. B67D 1/08; G01S 5/10; G06F 3/0484; B67D 1/00; G06F 3/0481; G06F 3/0482; H04B 5/00; B67D 1/07

(52) U.S. Cl. CPC B67D 1/0888; H04B 5/0062; H04B 5/0031; G01S 5/10; B67D 1/07; B67D 1/0021; G06F 3/04817; G06F 3/0482; G06F 3/04845

(57) ABSTRACT

Embodiments are provided for determining and managing an inventory. The position of an object in an inventory may be determined by utilizing an interrogator to send multiple request signals to a tag attached to the object. Each of the request signals may be communicated by the interrogator at a different frequency. The interrogator may then receive multiple reply signals from the tag. The interrogator may then determine the position of the tag (and thus the object) along a transmission line from phase measurements of the reply signals. A dispenser inventory may be managed. The dispenser may identify an ingredient packaging to be inserted into an ingredient matrix of the dispenser. The dispenser may then receive a user input of a location within the ingredient matrix where the identified ingredient packaging has been inserted.

This application is being filed on Sep. 15, 2016 as a national stage application based on PCT International Patent Application Number PCT/US2015/022253 filed Mar. 24, 2015, and claims priority from U.S. Provisional Patent Application No. 61/971,116, filed Mar. 27, 2014, the entire disclosures of which are incorporated by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

A number of different technologies may be utilized to determine the location of objects in an inventory. For example, radio frequency identification (RFID) tags may be affixed to objects to facilitate their identification in an inventory using one or more interrogators. Current methods utilizing RFID tags for determining an inventory however, suffer from a number of drawbacks. For example, in a cabinet (e.g., a dispenser) containing multiple objects, multiple antennas and interrogators may be utilized to identify individual objects. However, the use of multiple antennas and interrogators may be cost prohibitive for containers storing a large number of objects. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for determining and managing an inventory. In one embodiment, the position of an object in an inventory may be determined by utilizing an interrogator to send multiple request signals to a tag attached to the object. Each of the request signals may be communicated by the interrogator at a different frequency. The interrogator may then receive multiple reply signals from the tag. The interrogator may then determine the position of the tag (and thus the object) along a transmission line from phase measurements of the reply signals.

In another embodiment, a dispenser inventory may be managed. The dispenser may identify an ingredient packaging to be inserted into an ingredient matrix of the dispenser. The dispenser may then receive a user input of a location within the ingredient matrix where the identified ingredient packaging has been inserted.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a network architecture for determining an inventory using positional and non-positional awareness, in accordance with an embodiment;

FIG. 2 is a block diagram illustrating signaling between the interrogator and the tags of FIG. 1 for determining an inventory using positional awareness, in accordance with an embodiment;

FIG. 3A is a block diagram illustrating an antenna configuration for the dispenser in the network architecture of FIG. 1, in accordance with an embodiment;

FIG. 3B is a block diagram illustrating an antenna configuration for the dispenser in the network architecture of FIG. 1, in accordance with an alternative embodiment;

FIG. 4 is a flow diagram illustrating a routine for determining an inventory using positional and awareness, in accordance with an embodiment;

FIG. 5 is a block diagram illustrating a user interface display for updating a dispenser inventory using non-positional awareness, in accordance with an embodiment;

FIG. 6 is a block diagram illustrating a user interface display for updating a dispenser inventory using non-positional awareness, in accordance with an embodiment;

FIG. 7 is a block diagram illustrating a user interface display for updating a dispenser inventory using non-positional awareness, in accordance with an embodiment;

FIG. 8 is a block diagram illustrating a user interface display for updating a dispenser inventory using non-positional awareness, in accordance with an embodiment;

FIG. 9 is a block diagram illustrating a user interface display for updating a dispenser inventory using non-positional awareness, in accordance with an embodiment;

FIG. 10 is a block diagram illustrating a user interface display for updating a dispenser inventory using non-positional awareness, in accordance with an embodiment;

FIG. 11 is a block diagram illustrating a user interface display for updating a dispenser inventory using non-positional awareness, in accordance with an embodiment;

FIG. 12 is a block diagram illustrating a user interface display for updating a dispenser inventory using non-positional awareness, in accordance with an embodiment;

FIG. 13 is a block diagram illustrating a user interface display for updating a dispenser inventory using non-positional awareness, in accordance with an embodiment;

FIG. 14 is a block diagram illustrating a user interface display for updating a dispenser inventory using non-positional awareness, in accordance with an embodiment;

FIG. 15 is a block diagram illustrating a user interface display for updating a dispenser inventory using non-positional awareness, in accordance with an embodiment;

FIG. 16 is a block diagram illustrating a user interface display for updating a dispenser inventory using non-positional awareness, in accordance with an embodiment; and

FIG. 17 is a flow diagram illustrating a routine for updating a dispenser inventory using non-positional awareness, in accordance with an embodiment.

### DETAILED DESCRIPTION

Embodiments are provided for determining and managing an inventory. In one embodiment, the position of an object in an inventory may be determined by utilizing an interrogator to send multiple request signals to a tag attached to the object. Each of the request signals may be communicated by the interrogator at a different frequency. The interrogator may then receive multiple reply signals from the tag. The interrogator may then determine the position of the tag (and thus the object) along a transmission line from phase measurements of the reply signals.

In another embodiment, a dispenser inventory may be managed. The dispenser may identify an ingredient packaging to be inserted into an ingredient matrix of the dispenser. The dispenser may then receive a user input of a location within the ingredient matrix where the identified ingredient packaging has been inserted.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

It should be understood that “beverage,” as used herein, includes, but is not limited to, pulp and pulp-free citrus and non-citrus fruit juices, fruit drink, vegetable juice, vegetable drink, milk, soy milk, protein drink, soy-enhanced drink, tea, water, isotonic drink, vitamin-enhanced water, soft drink, flavored water, energy drink, coffee, smoothies, yogurt drinks, hot chocolate and combinations thereof. The beverage may also be carbonated or non-carbonated. The beverage may comprise beverage components (e.g., beverage bases, colorants, flavorants, and additives).

The term “beverage base” refers to parts of the beverage or the beverage itself prior to additional colorants, additional flavorants, and/or additional additives. According to certain embodiments of the present invention, beverage bases may include, but are not limited to syrups, concentrates, and the like that may be mixed with a diluent such as still or carbonated water or other diluent to form a beverage. The beverage bases may have reconstitution ratios of about 3:1 to about 6:1 or higher. According to certain embodiments, beverage bases may comprise a mixture of beverage base components.

The term “beverage base component” refers to components which may be included in beverage bases. According to certain embodiments of the present invention, the beverage base component may comprise parts of beverages which may be considered food items by themselves. According to certain embodiments of the present invention, the beverage base components may be micro-ingredients such as an acid portion of a beverage base, an acid-degradable and/or non-acid portion of a beverage base, natural and artificial flavors, flavor additives, natural and artificial colors, nutritive or non-nutritive natural or artificial sweeteners, additives for controlling tartness (e.g., citric acid or potassium citrate), functional additives such as vitamins, minerals, or herbal extracts, nutraceuticals, or medicaments. The micro-ingredients may have reconstitution ratios from about 10:1, 20:1, 30:1, or higher with many having reconstitution ratios of 50:1 to 300:1. The viscosities of the micro-ingredients may range from about 1 to about 100 centipoise.

Thus, for the purposes of requesting, selecting, or dispensing a beverage base, a beverage base formed from separately stored beverage base components may be equivalent to a separately stored beverage base. For the purposes of requesting, selecting or dispensing a beverage, a beverage formed from separately stored beverage components may be equivalent to a separately stored beverage.

By “separately stored” it is meant that the components of the present invention are kept separate until combined. For instance, the components may be separately stored individually in each container or may be all stored in one container wherein each component is individually packaged (e.g., plastic bags) so that they do not blend while in the container. In some embodiments, the container, itself, may be individual, adjacent to, or attached to another container.

The term “blended beverage” includes final products wherein two or more beverages have been blended or mixed or otherwise combined to form a final product.

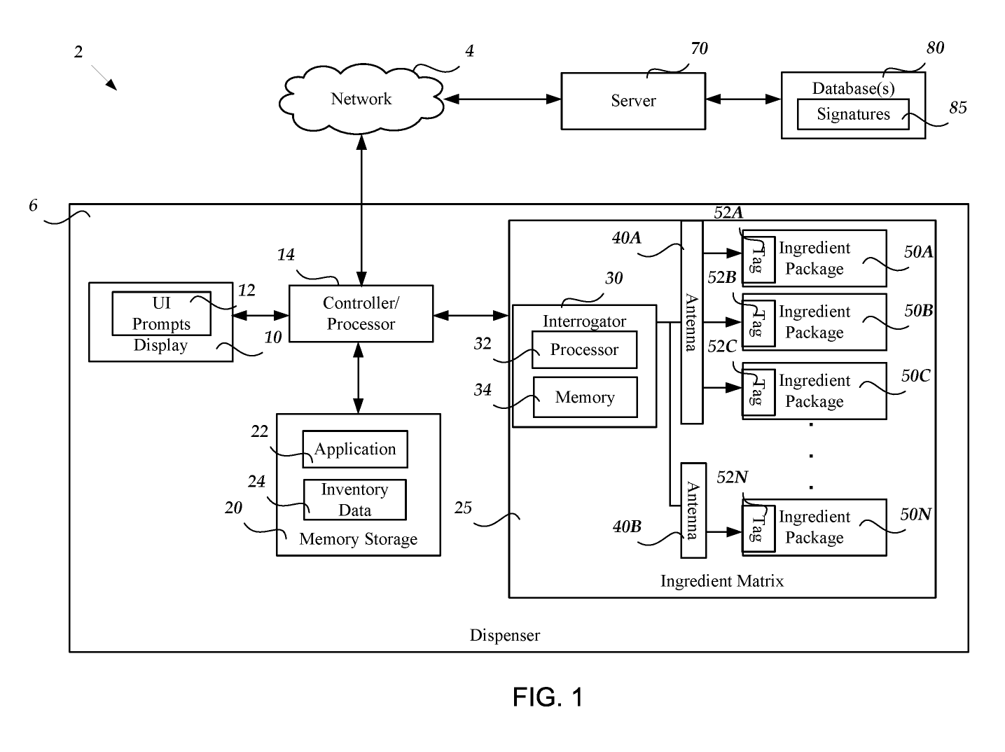

Referring now to the drawings, in which like numerals represent like elements through the several figures, various aspects of the present invention will be described. FIG. 1 is a block diagram illustrating a network architecture 2 for determining an inventory using positional and non-positional awareness, in accordance with an embodiment. The network architecture 2 includes a dispenser 6 which may be in communication with a server 70 over a network 4 which may include a local network or a wide area network (e.g., the Internet). In some embodiments, the dispenser 6 in the network architecture 2 may be replaced with one or more devices, containers or surfaces used to store or display tagged objects (e.g., RFID-tagged items) in an inventory including, but not limited to, back room beverage base and/or beverage base component storage cabinets or shelves, printers (e.g., cartridges), display cabinets (e.g., jewelry), other shelving (e.g., for pharmaceutical bottles, clothing items, etc.) and playing boards (e.g., game pieces). In some embodiments the objects may include packaging (e.g., ingredient packages) for storing a beverage product including, without limitation, cartridges, cartons, “bags-in-boxes,” or other beverage ingredient or finished beverage packaging.

In the network architecture 2, the dispenser 6 may include a display 10, a controller/processor 14, memory storage 20 and an ingredient matrix 25. The display 10 may be utilized to display UI prompts for interacting with various functionality provided by the dispenser 6 including accessing various customer menus for replacing ingredient packaging, cleaning (i.e., flushing) and priming the dispenser 6. In some embodiments, the memory storage 20 may comprise, but is not limited to, volatile (e.g. random access memory (RAM)), non-volatile (e.g. read-only memory (ROM)), flash memory, or any combination. The memory storage 20 may include an operating system (not shown), an application 22, and inventory data 24.

The dispenser 6 may have additional features or functionality. For example, the dispenser 6 may also include additional data storage devices (not shown) which may be removable and/or non-removable such as, for example, magnetic disks, optical disks, solid state storage devices (“SSD”), flash memory or tape. The dispenser 6 may also have input devices such as a keyboard, a mouse, a pen, a sound input device (e.g., a microphone), a touch input device, etc., as well as output devices, such as a display, speakers, a printer, etc. which may also be included. The aforementioned devices are examples and others may be used. Communication connections may also be included and utilized to connect to the Internet (or other types of networks) as well as to remote computing systems.

Various embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information (such as computer readable instructions, data structures, program modules, or other data) in hardware. The memory storage 20 is an example of computer storage media (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the dispenser 6. Any such computer storage media may also be part of the dispenser 6. Computer storage media does not include a carrier wave or other propagated or modulated data signal.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The ingredient matrix 25 may include an interrogator 30 which is in communication with antennas 40A and 40B. The ingredient matrix 25 may further include ingredient packages 50A, 50B, 50C and 50N. The ingredient packages 50A-50N may be affixed with tags 52A, 52B, 52C and 52N. The interrogator 30, which may include a processor 32 and a memory 34, may comprise an RFID reader/writer utilized to read and write information associated with conducting an inventory, to the tags 52A-52N. The tags 52A-52N may comprise RFID tags which, in some embodiments, may comprise MONZA series RFID tag chips manufactured by IMPINJ CORPORATION of Seattle, Wash. The tags 52A-52N may include, but are not limited to, active tags, passive tags, RFID, NFC and/or other wireless communication tags. It should be understood, that in some embodiments, communications between the interrogator 30 and the tags 52A-52N may utilize RFID communications protocols, such as the EPC Air Interface Standard, developed by EPCGLOBAL, INC. As should be known to those skilled in the art, the specification for the EPC Air Interface Standard defines the physical and logical requirements for a passive-backscatter, Interrogator-talks-first (ITF), RFID system operating in the 860 MHz-960 MHz frequency range. The system comprises Interrogators, also known as Readers, and Tags, also known as Labels. An Interrogator transmits information to a Tag by modulating an RF signal in the 860 MHz-960 MHz frequency range. The Tag received both information and operating energy from this RF signal. Tags are passive, meaning that they receive all of their operating energy from the Interrogator's RF wave form. An Interrogator receives information from a Tag by transmitting a continuous-wave (CW) RF signal to the Tag; the Tag responds by modulating the reflection coefficient of its antenna, thereby backscattering an information signal to the Interrogator. The system is ITF, meaning that a Tag modulates its antenna reflection coefficient with an information signal only after being directed to do so by an Interrogator. Interrogators and Tags are not required to talk simultaneously; rather, communications are half-duplex, meaning that Interrogators talk and Tags listen, or vice versa.

The interrogator 30 may communicate through the antennas 40A and 40B to the tags 52A-52N on the ingredient packages 50A-50N. In some embodiments, the ingredient packages 50A-50N may comprise removable cartridges which may be automatically identified upon installation by the dispenser (e.g., via the interrogator 30 reading the tags 52A-52N) or, alternatively, a user may be prompted to identify the ingredient packages 50A-50N when there are installed. It should be appreciated that the ingredient packages 50A-50N may contain the aforementioned beverage components (i.e., beverage bases or beverage base components and flavors) and that these beverage components may be combined, along with other beverage ingredients, to dispense various products which may include beverages or blended beverages (i.e., finished beverage products) from the dispenser 6. It should be understood however, that the dispenser 6 may also be configured to dispense the beverage components individually.

The server 70 may facilitate communications between the dispenser 6 and the database 80. The database 80 may store one or more signatures 85 which, as will be described in greater detail herein, may comprise inventory locations or positions, associated with each of the ingredient packages 50A-50N in the dispenser 6, which are determined by phase and frequency measurements received by the interrogator 30. In some embodiments, the signatures 85 may also be stored in the memory storage 20 of the dispenser 6. In other embodiments, the signatures are not stored but instead may be calculated as a function. For example, a function may be implemented in software/firmware that receives phase and frequency measurements as input parameters, and after running through them through the function, output a position associated with a corresponding object (e.g., one of the ingredient packages 50A-50N in the dispenser 6).

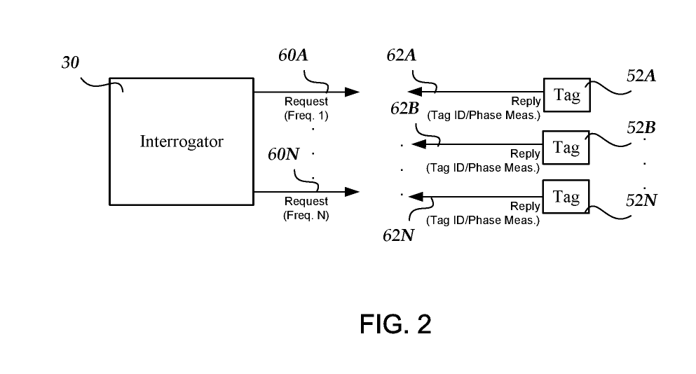

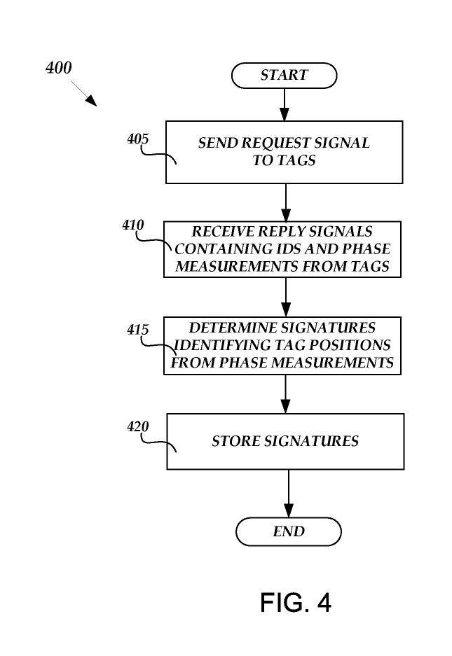

FIG. 2 is a block diagram illustrating signaling between the interrogator 30 and the tags 52A-52N of FIG. 1 for determining an inventory using positional awareness, in accordance with an embodiment. As will be described in greater detail below with respect to FIG. 4, the interrogator 30 may be configured to send Request signals 60A-60N to each of the tags 52A-52N and receive Reply signals 62A, 62B and 62N from the interrogated tags 52A-52N in order to identify tag locations. In some embodiments, each of the Reply signals 62A-62N may include a Tag ID associated with the tags 52A-52N. The interrogator 30 may take a phase measurement of the Reply signals 62A-62N for identifying tag locations. Moreover, each of the Request signals 60A-60N may be sent at a different frequency which enables multiple phase measurements to be made from each of the tags 52A-52N for identifying tag locations (which will be discussed in detail below). It should be understood that in some embodiments, the interrogator 30 may be configured to identify individual tags in a multi-tag population utilizing techniques such as simulation algorithms and anti-collision mitigation mechanisms such as those provided by the UHF EPC Gen2 standard (which is part of the specification for the EPC Air Interface Standard, discussed above with respect to FIG. 1). Furthermore, the interrogator 30 may be configured to determine the phase (or a representation thereof—i.e., the phase measurement unit does not need to be in radians or degrees), of a received Reply signal 62A, 62B or 62N. Furthermore, the interrogator 30 may be configured to operate at multiple frequencies and identify a particular frequency it is operating on when it receives the Tag ID and associated phase measurement. It should also be understood that in some embodiments, an RF transmission line distance may not be the same for two tags. In some embodiments, each of the tags 52A-52N is located at a distinct RF transmission line distance. The transmission line may be a one dimensional straight line or zig-zag back and forth to cover a two or even three dimensional space where the tags 52A-52N are located at unique positions along an RF transmission line. It should be understood that the positions of the tags 52A-52N may be relative (i.e., discrete locations) or absolute. Relative positions may include, without limitation, assigned cabinets, cubbies, shelf positions, or other relative positions along a transmission line. With respect to the dispenser 6, relative positions may include distinct slots within the ingredient matrix 25 adapted to receive ingredient packaging. It should also be understood that absolute positions may be calculated as transmission line distance where the accuracy of the absolute position increases with an increased number of communications between the interrogator 30 and the tags 52A-52N.

It should be understood that in an RFID system, the phase at which an RFID tag signal is received by an interrogator receiver circuit (which may be determined by the relative magnitude of the I and Q channel signals) is a function of the path distance to the tag (including physical transmission line elements and the wireless distance). Thus, for multiple tags in multiple positions, each tag may be associated with a phase. However, as phase is cyclic as a function of wavelength, for a given frequency, multiple tags may present the same or similar phases to the interrogator. Therefore, an adjustment of frequency (i.e., sending each of the Request signals 60A-60N at different frequencies) will lead to changes in apparent phase at a given position since the wavelengths will be different. Thus, for a given tag position, several phases may be measured for several frequencies. It should be appreciated that the aforementioned phases may be used as a unique signature for a given tag in a given position since, even if a second tag position has the same phase at a certain frequency, it is unlikely to have the same phase at all frequencies due to lower frequencies having a shorter wavelength. It should be further appreciated that if a number of discrete tag locations are approximately known, (as in the case of the ingredient packages 50A-50N associated with the tags 52A-52N), for each tag location, a number of phase measurements may be made at different frequencies. This set of phases then becomes the unique phase “signature” for a tag position. It should be understood that the phase signature of a location may be calibrated at a factory. Furthermore, the phase signature of a tag may be determined “on-the-fly” based on the phases of reply signals from the tag. In addition, the phase signature of a tag may be correlated to the phase signature of a location to determine the location of the tag (i.e., which slot within the ingredient matrix 25 the tag and corresponding ingredient package are located).

In some embodiments, the respective locations of the tags 52A-52N may be found during a factory calibration of the dispenser 6. Furthermore, if a new tag is introduced to the dispenser 6 into one of the discrete tag locations, its phase signature may then be used to identify its absolute position in the dispenser 6.

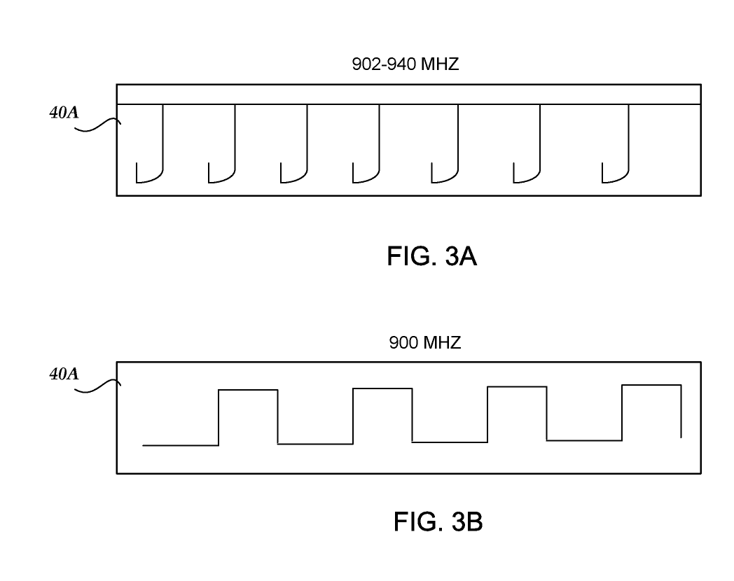

FIGS. 3A-3B are block diagrams illustrating different antenna configurations for the dispenser 6 in the network architecture 2 of FIG. 1, in accordance with various embodiments. For example, FIG. 3A shows a configuration of an antenna 40A which is designed to resonate in a frequency range between 902 and 940 MHz while FIG. 3B shows a configuration of the antenna 40A which is designed to resonate at a frequency of 900 MHz. In some embodiments, the antenna 40A may comprise a microstrip or “patch” antenna which is a narrowband, wide-beam antenna fabricated by etching an antenna element pattern in metal trace bonded to an insulating dielectric substrate, such as a printed circuit board, with a continuous metal layer bonded to the opposite side of the substrate which forms a ground plane.

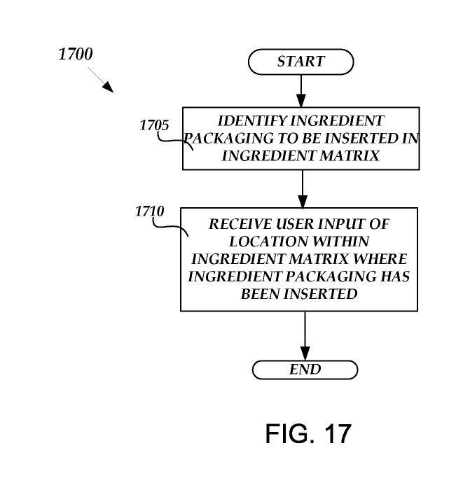

FIG. 4 is a flow diagram illustrating a routine 400 for determining an inventory using positional awareness, in accordance with an embodiment. When reading the discussion of the routines presented herein, it should be appreciated that the logical operations of various embodiments of the present invention are implemented (1) as a sequence of computer implemented acts or program modules running on a computing device or system and/or (2) as interconnected machine logical circuits or circuit modules within the computing device or system. The implementation is a matter of choice dependent on the performance requirements of the computing device or system implementing the invention. Accordingly, the logical operations illustrated in FIGS. 4 and 17 and making up the various embodiments described herein are referred to variously as operations, structural devices, acts or modules. It will be recognized by one skilled in the art that these operations, structural devices, acts and modules may be implemented in software, in firmware, in hardware, in special purpose digital logical, and any combination thereof without deviating from the spirit and scope of the present invention as recited within the claims set forth herein.

The routine 400 begins at operation 405, where the interrogator 30 in the dispenser 6 may send the request signal 60A to the tags 52A-52N which are associated with multiple objects, such as the ingredient packages 50A-50N. In particular, the interrogator 30 may send the request signals 60A-60N to each of the tags 52A-52N at different frequencies.

From operation 405, the routine 400 continues to operation 410, where the interrogator 30 in the dispenser 6 may receive the reply signals 62A-62N containing tag IDs and phase measurements from the tags 52A-52N. In particular, the interrogator 30 may receive different phase measurements corresponding to each of the different frequencies over which the request signals 60A-60N were sent to the tags 52A-52N.

From operation 410, the routine 400 continues to operation 415, where the interrogator 30 in the dispenser 6 may determine the signatures 85 identifying the positions of the tags 52A-52N in the dispenser 6, from phase measurements received at operation 410. In particular, interrogator 30 may identify a set of phases comprising different phase measurements received from each of the tags 52A-52N affixed to the ingredient packages 50A-50N.

From operation 415, the routine 400 continues to operation 420, where the interrogator 30 in the dispenser 6, may store the signatures 85 in the database 80. As discussed above, each of the signatures 85 may be unique in that each represents a number of phase measurements made at different frequencies. The signatures 85 may be utilized to identify the positions of the tags 52A-52N (and thus, the ingredient packages 50A-50N) in the dispenser 6. It should be understood that the inventory determination described by the routine 400 may not only determine which of the tags 52A-52N (and thus, the ingredient packages 50A-50N) are installed in the dispenser 6 but where they are installed (i.e., their locations or which slot within the ingredient matrix 25) within the dispenser 6 as well. From operation 420, the routine 400 then ends.

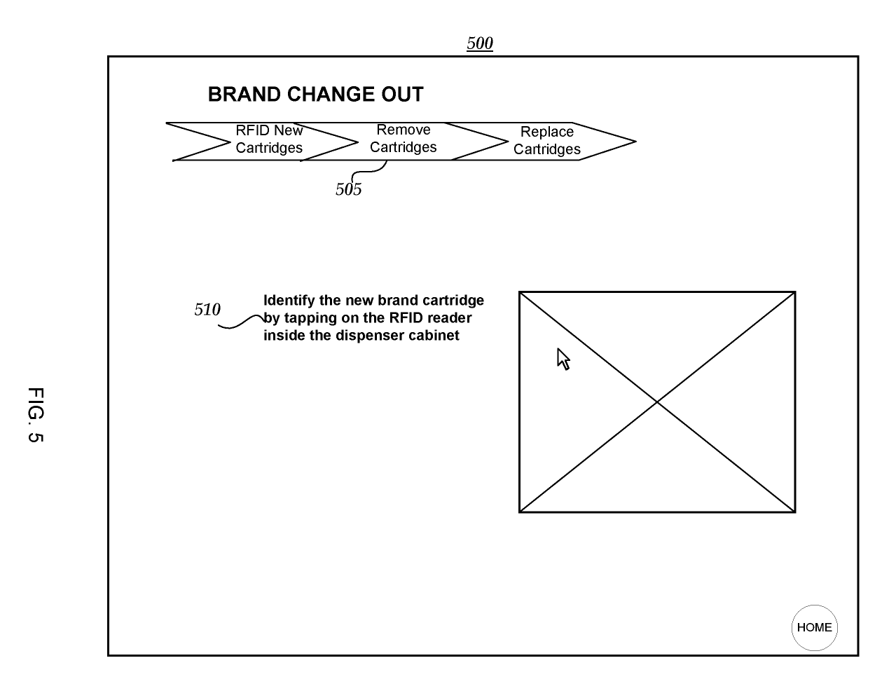

FIG. 5 is a block diagram illustrating a user interface 500 for updating a dispenser inventory using non-positional awareness, in accordance with an embodiment. It should be understood that in using “non-positional awareness,” the interrogator 30 may issue inventory requests and receive a reply from each of the tags 52A-52N that may include a tag I.D. Furthermore, the inventory requests may not be made over multiple frequencies and phase measurements may not be taken on the replies. Thus, the dispenser 6 may be configured to determine which of the ingredient packages 50A-50N are installed but may not be able to measure (or determine) a location where a particular ingredient package is installed within the dispenser 6.

The user interface 500 may comprise a “Brand Change Out” screen for replacing packaging (e.g., the ingredient packages 50A-50N) in the dispenser 6. The user interface 500 may display a menu 505 which shows a series of steps involved in identifying, removing and replacing packaging in the dispenser 6. The user interface 500 also includes instructions 510, associated with an RFID Reader/Writer (such as the interrogator 30), for identifying packaging to be inserted into the ingredient matrix 25 of the dispenser 6. For example, the dispenser 6 may comprise a cabinet which includes an RFID reader. Upon the RFID reader reading a tag, the dispenser 6 may determine that an ingredient package, corresponding to the read tag, is to be inserted into the dispenser 6. As will be described in greater detail below with respect to FIG. 17, the dispenser 6 may be configured to generate user interface displays (described in FIGS. 5-16) which may be utilized by a customer to ascertain inventory locations for packaging in various slots of the dispenser 6 and the identification of slots in which to install new packaging, without needing to have foreknowledge of the dispenser's 6 packaging configuration.

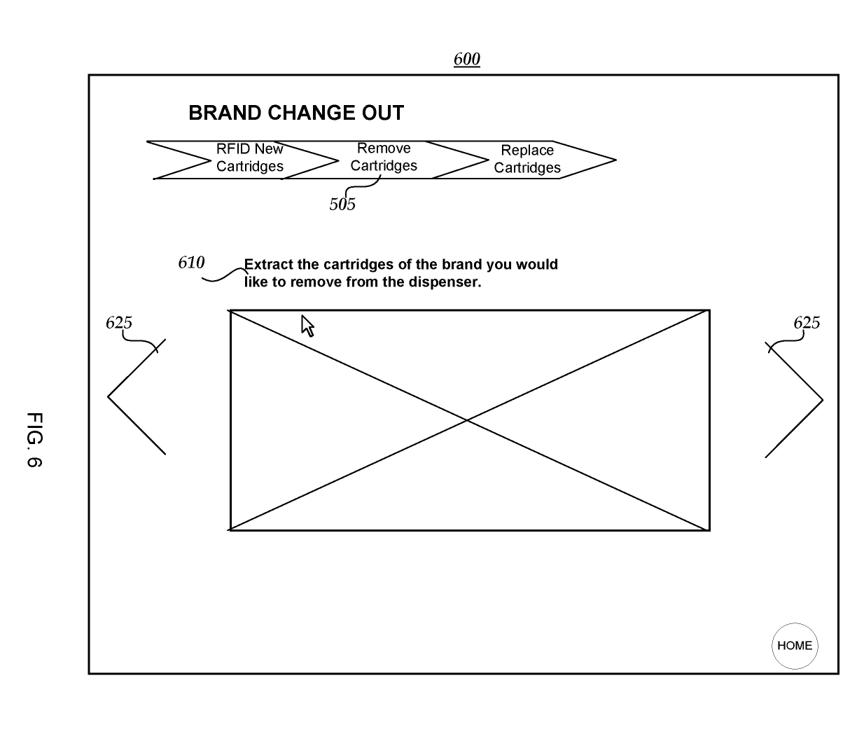

FIG. 6 is a block diagram illustrating a user interface 600 for updating a dispenser inventory using non-positional awareness, in accordance with an embodiment. The user interface 600 may comprise a “Brand Change Out” screen for replacing packaging (e.g., the ingredient packages 50A-50N) in the dispenser 6. The user interface 600 may display the menu 505 which shows a series of steps involved in identifying, removing and replacing packaging in the dispenser 6. The user interface 600 also includes instructions 610 directing a customer on how to remove packaging from the dispenser 6 for replacing with new packaging. For example, upon removal of one or more of the ingredient packages 50A-50N, an inventory of the ingredient packages installed in the dispenser 6 may enable the dispenser 6 to determine which ingredient packages were removed. The user interface 600 further includes directional controls 625 for navigating between various user interface screens generated by the dispenser 6.

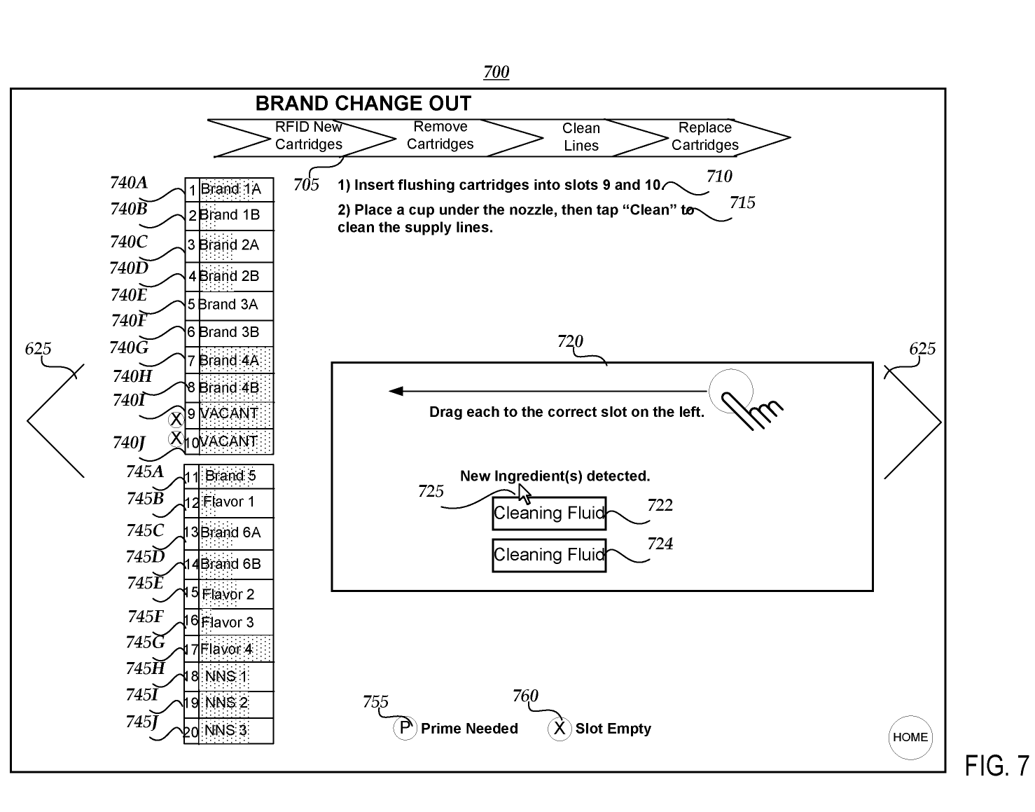

FIG. 7 is a block diagram illustrating a user interface 700 for updating a dispenser inventory using non-positional awareness, in accordance with an embodiment. The user interface 700 may comprise a “Brand Change Out” screen for replacing packaging (e.g., the ingredient packages 50A-50N) in the dispenser 6 which may include dispenser packaging slots 740A-740J and 745A-745J. The user interface 700 may display a menu 705 which shows a series of steps involved in identifying, removing, cleaning dispenser supply lines and replacing packaging in the dispenser 6. The user interface 700 also includes instructions 710 and 715 directing a customer on how to add identified packaging to the ingredient matrix 26. For example, the ingredient packages 50A-50N to be added may be identified as described above with respect to FIG. 5. In the example shown in FIG. 7, flush packaging is identified and instructions 710 and 715 are provided to flush dispenser packaging slots 7401 and 740J through the insertion of flushing packaging as well as how to clean the dispenser supply lines associated with the dispenser packaging slots 7401 and 740J. Each of the dispenser packaging slots 740A-740J and 745A-745J displayed in the user interface 700 may also include various amounts of highlighting to identify an ingredient level (e.g., a brand, flavor or non-nutritive sweetener (NNS) level) remaining in a packaging inserted in one of the dispenser packaging slots 740A-740J and 745A-745J. For example, in some embodiments, the dispenser packaging slot 740A, which is shown as being more than 70% highlighted, may indicate that the level of Brand 1A in a dispenser packaging is nearing depletion while the dispenser packaging slot 740E, which is shown with no highlighting, may indicate that the level of Brand 3A in a dispenser packaging is full. It should be understood however, that other means of indicating a dispenser packaging ingredient level may also be utilized. The user interface 700 also includes an instruction panel 720 which may include instructions in the form of pictograms, text and/or other indicia for directing a customer to clean one or more dispenser supply lines associated with a dispenser packaging slot. For example, the instruction panel 720 instructs a customer on how to prepare for the cleaning of dispenser supply lines by dragging flushing packaging icons 722 and 724 to vacant dispenser packaging slots 7401 and 740J (e.g., by using pointer 725). The user interface 700 also displays a dispenser packaging slot legend which may include icons 755 and 760 for identifying dispenser packaging which needs to be primed and empty dispenser packaging slots in the dispenser 6.

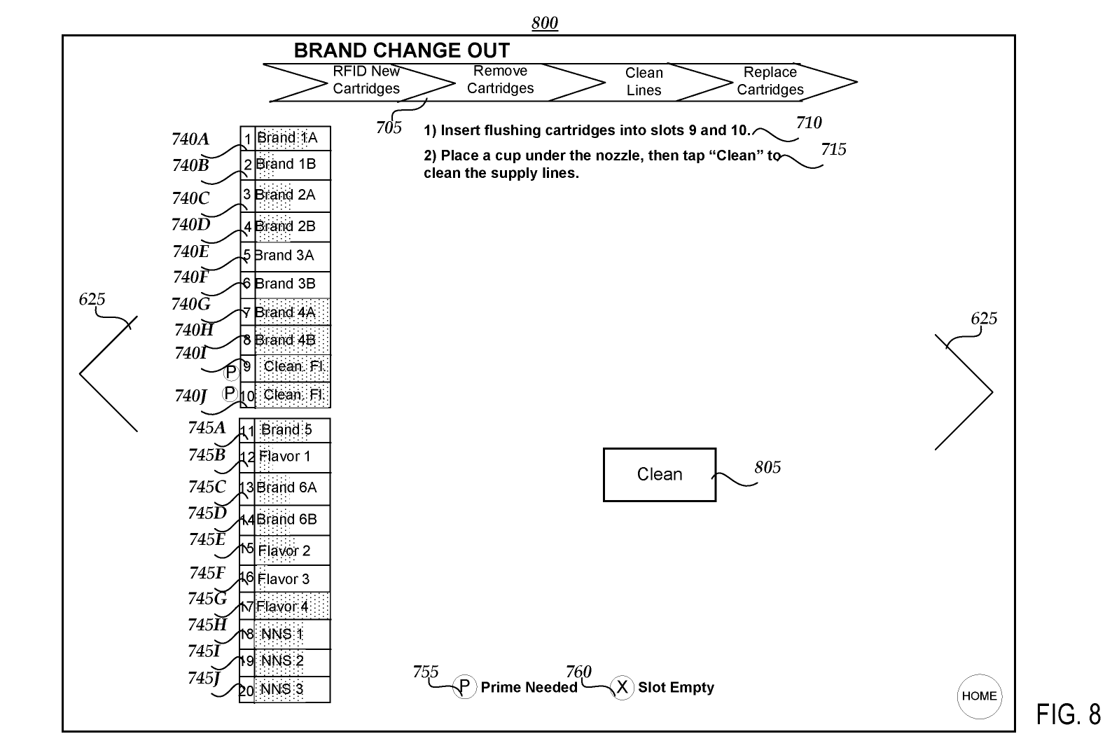

FIG. 8 is a block diagram illustrating a user interface 800 for updating a dispenser inventory using non-positional awareness, in accordance with an embodiment. The user interface 800, which may be generated by the dispenser 6 after a customer has dragged flushing packaging icons 722 and 724 to the vacant dispenser packaging slots 7401 and 740J, may display a selectable user control 805 for initiating the cleaning of the dispenser supply lines associated with the dispenser packaging slots 7401 and 740J. Upon selection of the selectable user control 805, the dispenser 6 may operate one or more pumps to pump cleaning fluid through dispenser plumbing, to a nozzle or other cleaning fluid dispense port (not shown). The text displayed over the dispenser packaging slots 7401 and 740J is also changed to identify the contents (i.e., Cleaning Fluid) of the flushing packaging previously inserted by the customer.

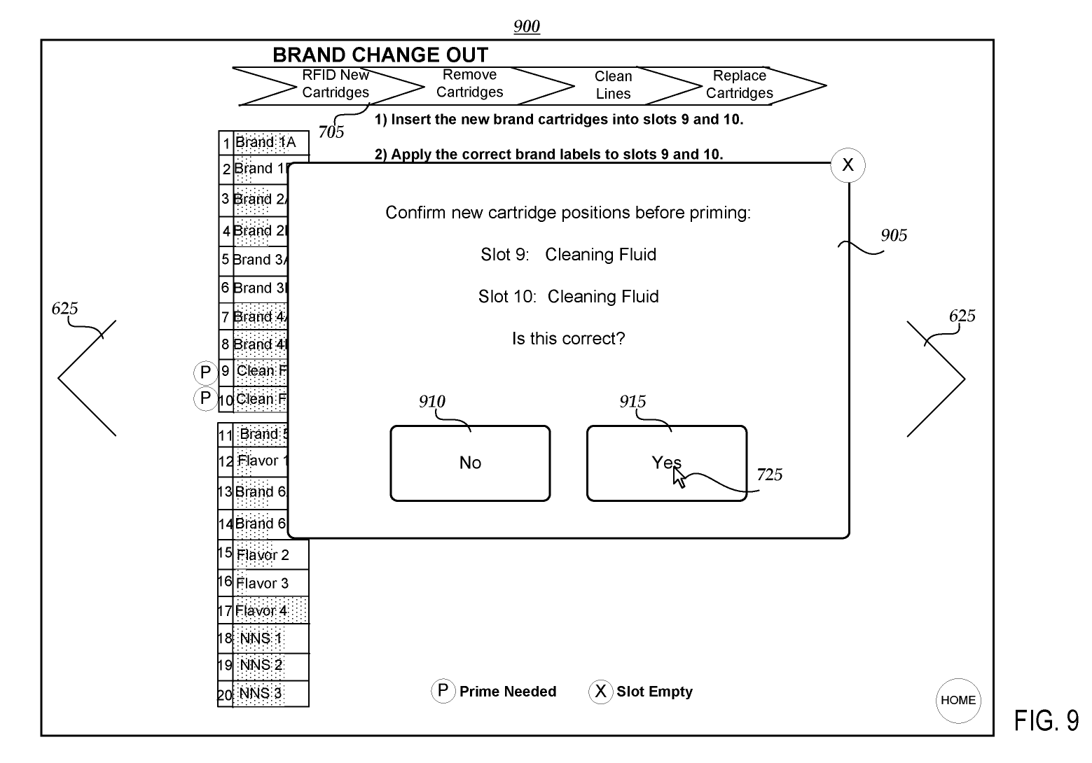

FIG. 9 is a block diagram illustrating a user interface 900 for updating a dispenser inventory using non-positional awareness, in accordance with an embodiment. The user interface 900, which may be generated by the dispenser 6 after a customer has selected the selectable user control 805 for initiating the cleaning of the dispenser supply lines associated with the dispenser packaging slots 7401 and 740J, may display a confirmation panel 905 which confirms that the flushing packaging containing cleaning fluid have been inserted and which includes selectable option buttons 910 and 915 for accepting or cancelling cleaning of the dispenser supply lines.

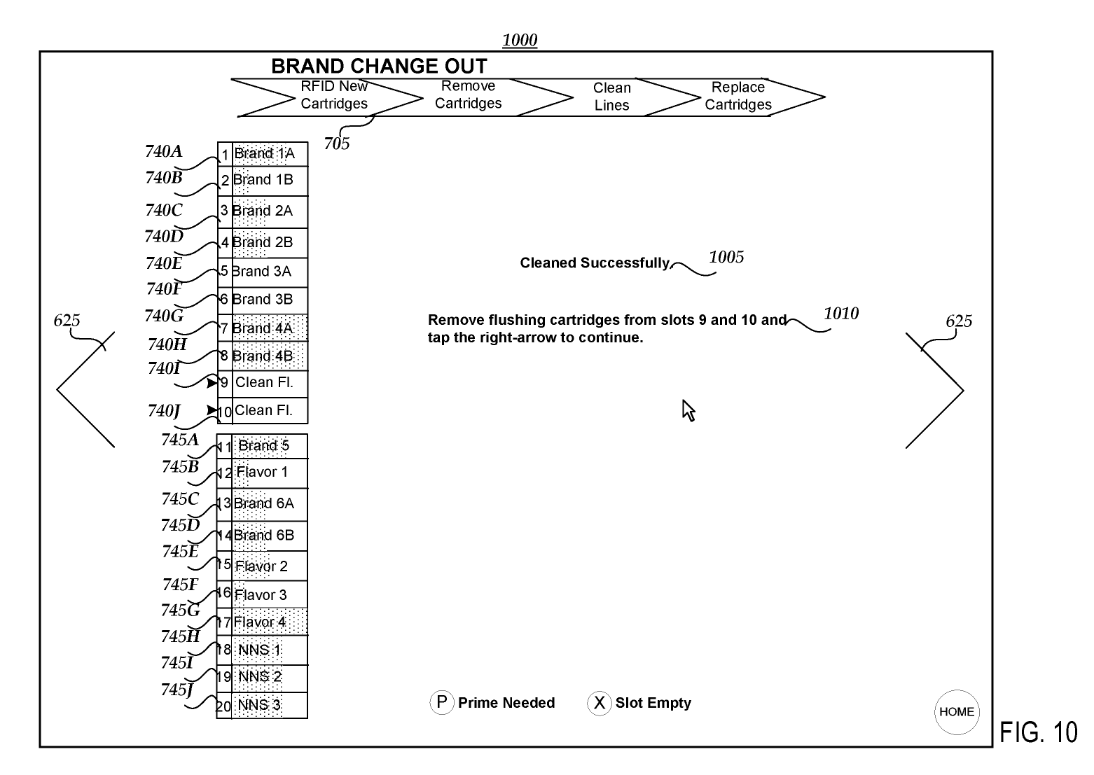

FIG. 10 is a block diagram illustrating a user interface 1000 for updating a dispenser inventory using non-positional awareness, in accordance with an embodiment. The user interface 1000 may display instructions 1005 and 1010 for confirming the cleaning of the dispenser supply lines and for the customer to remove the flushing packaging from the dispenser packaging slots 7401 and 740J.

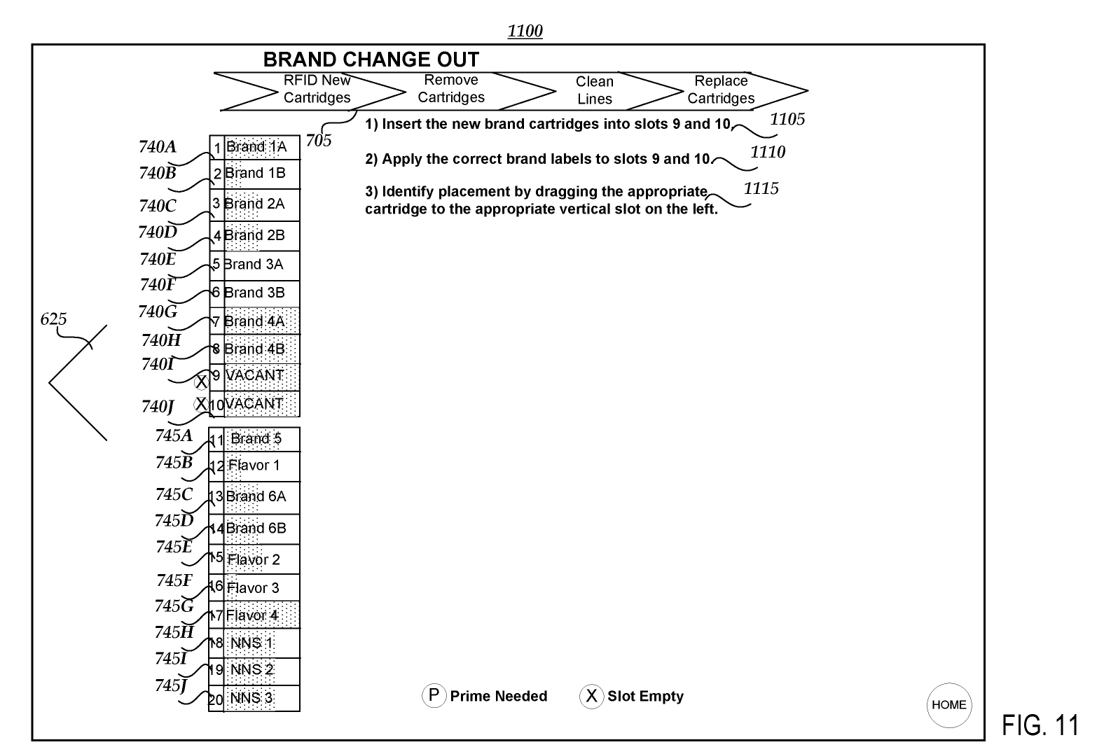

FIG. 11 is a block diagram illustrating a user interface 1100 for updating a dispenser inventory using non-positional awareness, in accordance with an embodiment. The user interface 1100 may display instructions 1105, 1110 and 115 for a customer to insert new packaging into the previously cleaned dispenser packaging slots 7401 and 740J, apply brand labels for identifying the brand associated with the new packaging to the dispenser packaging slots 7401 and 740J and identify the placement of the inserted new packaging by dragging to one of the dispenser packaging slots 740A-740J and 745A-745J. Thus, it should be understood that the dispenser 6 may determine where each of the new packaging is located within the ingredient matrix 25 in accordance with received user input indicating where the user is inserting (i.e., installing) the new packaging.

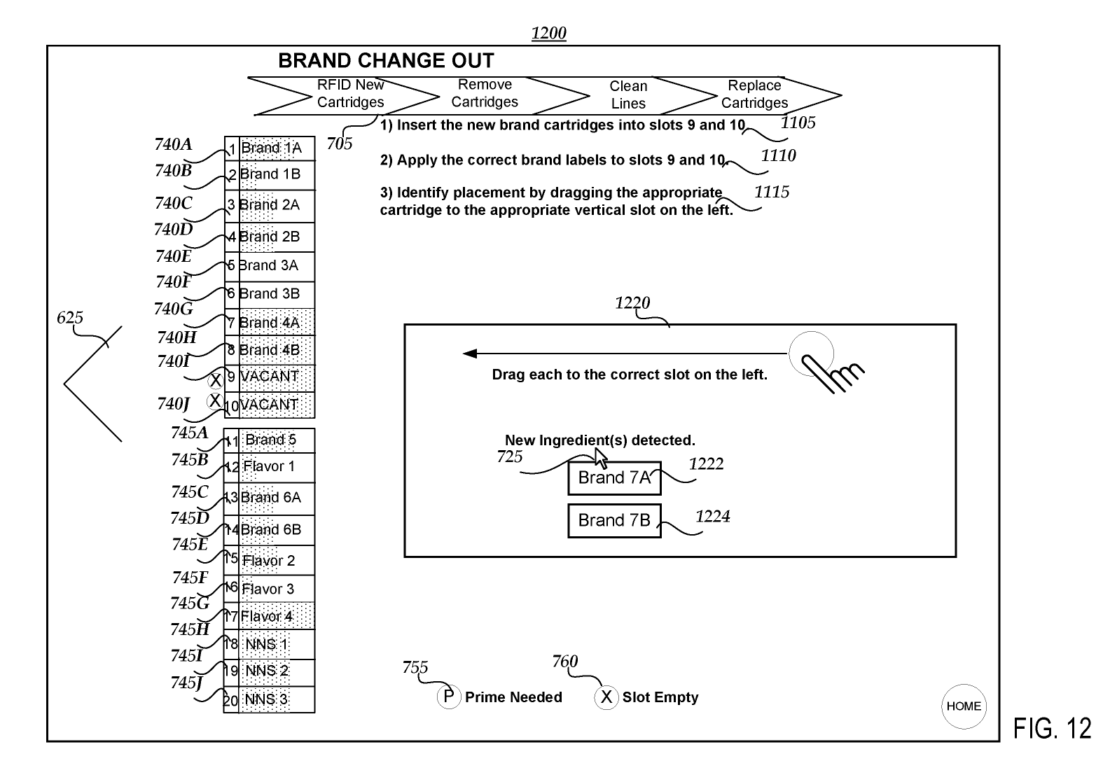

FIG. 12 is a block diagram illustrating a user interface 1200 for updating a dispenser inventory using non-positional awareness, in accordance with an embodiment. The user interface 1200 may display an instruction panel 1220 which may include instructions in the form of pictograms, text and/or other indicia for directing a customer to confirm the insertion of new ingredient packaging in the dispenser 6. For example, the instruction panel 1220 instructs a customer on how to confirm the insertion of new ingredient packaging by dragging identified packaging brand icons 1222 and 1224 to vacant dispenser packaging slots 7401 and 740J (e.g., by using pointer 725). As discussed above with respect to FIG. 5, the ingredient packaging may be identified upon the dispenser 6 reading a corresponding tag affixed to the ingredient packaging via a reader in the dispenser 6. The customer may then drag the ingredient packaging brand icons 1222 and 1224 to a location in the virtual representation of the ingredient matrix 25 where the customer physically installed (or will physically install) the ingredient packaging in the ingredient matrix 25.

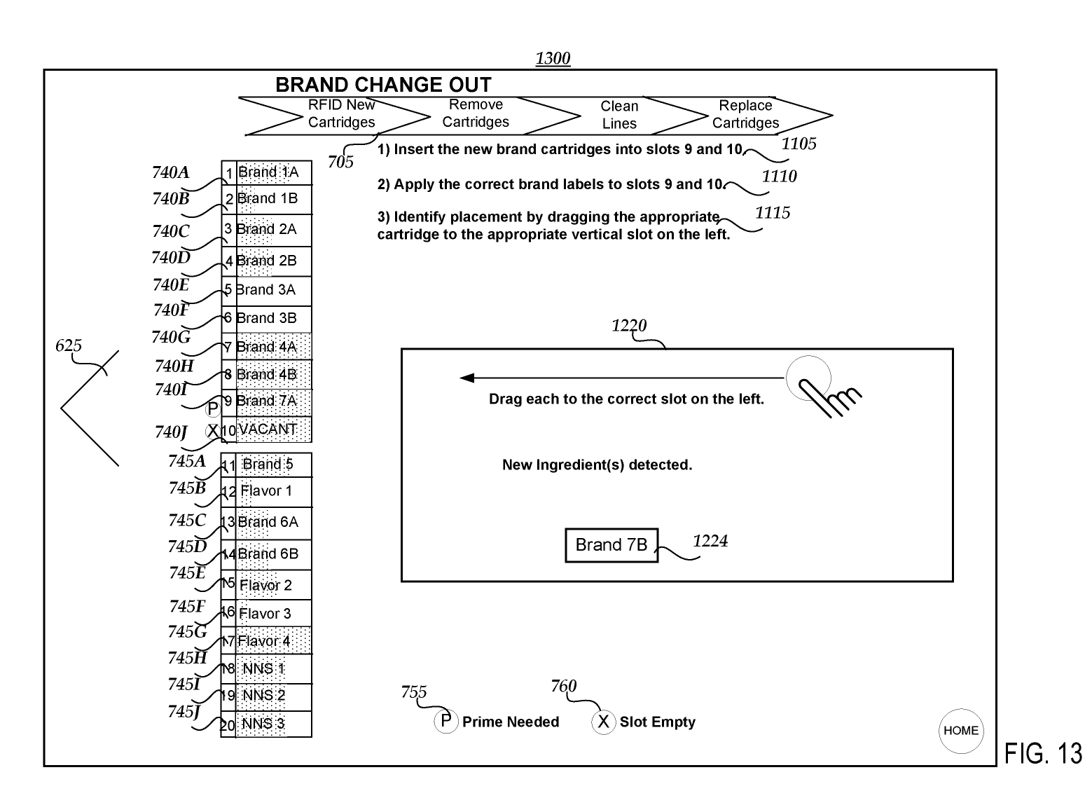

FIG. 13 is a block diagram illustrating a user interface 1300 for updating a dispenser inventory using non-positional awareness, in accordance with an embodiment. The user interface 1300 displays the instruction panel 1220 showing only the packaging brand icon 1224 after the packaging brand icon 1222 has been dragged to the dispenser packaging slot 7401.

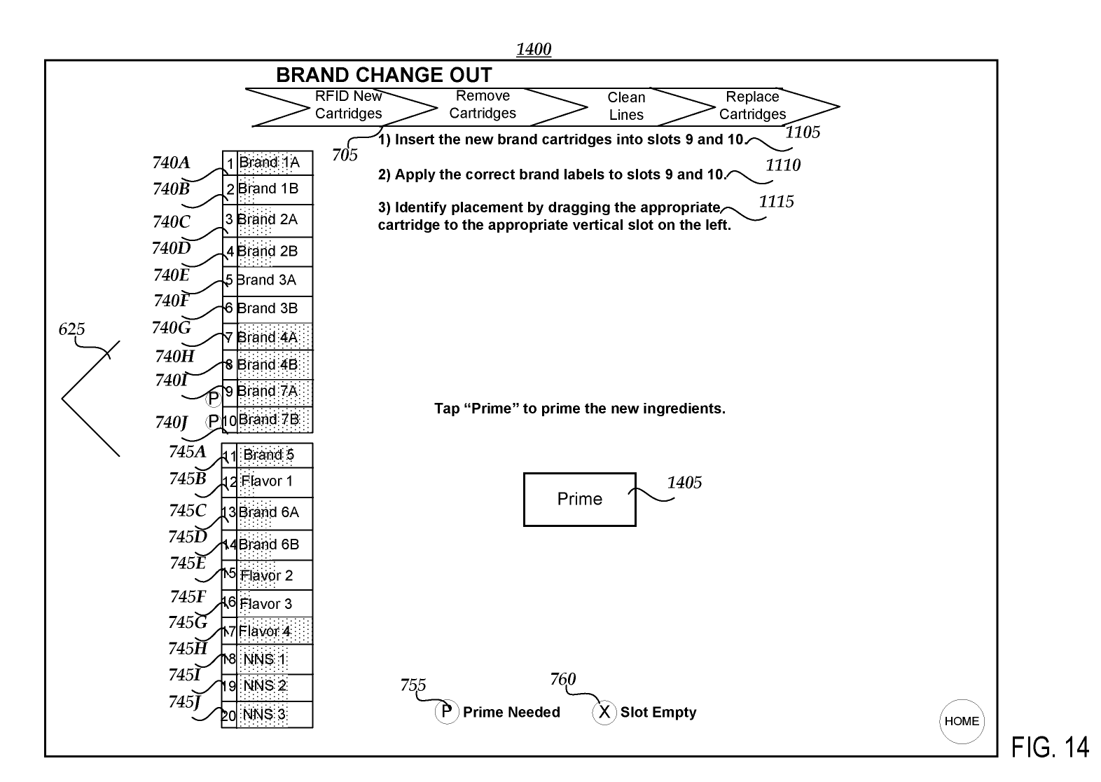

FIG. 14 is a block diagram illustrating a user interface 1400 for updating a dispenser inventory using non-positional awareness, in accordance with an embodiment. The user interface 1400, which may be generated by the dispenser 6 after a customer has dragged packaging brand icons 1222 and 1224 to the vacant dispenser packaging slots 7401 and 740J, may display a selectable user control 1405 for initiating priming of the new packaging ingredients in the dispenser packaging slots 7401 and 740J. The text displayed over the dispenser packaging slots 7401 and 740J is also changed to identify the contents (i.e., Brand 7A and Brand 7B) of the new packaging previously inserted into the dispenser 6 by the customer. Upon selection of the selectable user control 1405, the dispenser 6 may pump fluid from the ingredient packaging in a sufficient volume to prime dispenser supply lines from the ingredient packaging to a dispenser nozzle.

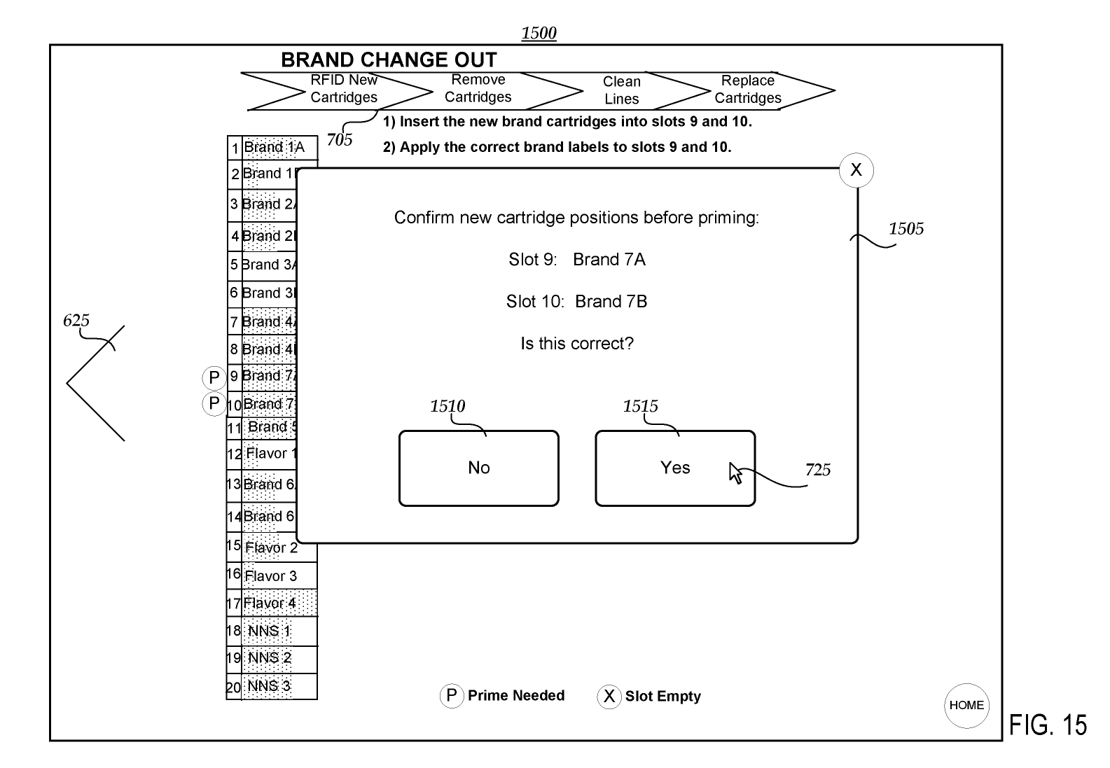

FIG. 15 is a block diagram illustrating a user interface 1500 for updating a dispenser inventory using non-positional awareness, in accordance with an embodiment. The user interface 1500, which may be generated by the dispenser 6 after a customer has selected the selectable user control 1405 for initiating priming of the new packaging ingredients in the dispenser packaging slots 7401 and 740J, may display a confirmation panel 1505 which confirms that the new packaging have been inserted and which includes selectable option buttons 1510 and 1515 for accepting or cancelling priming the new packaging ingredients.

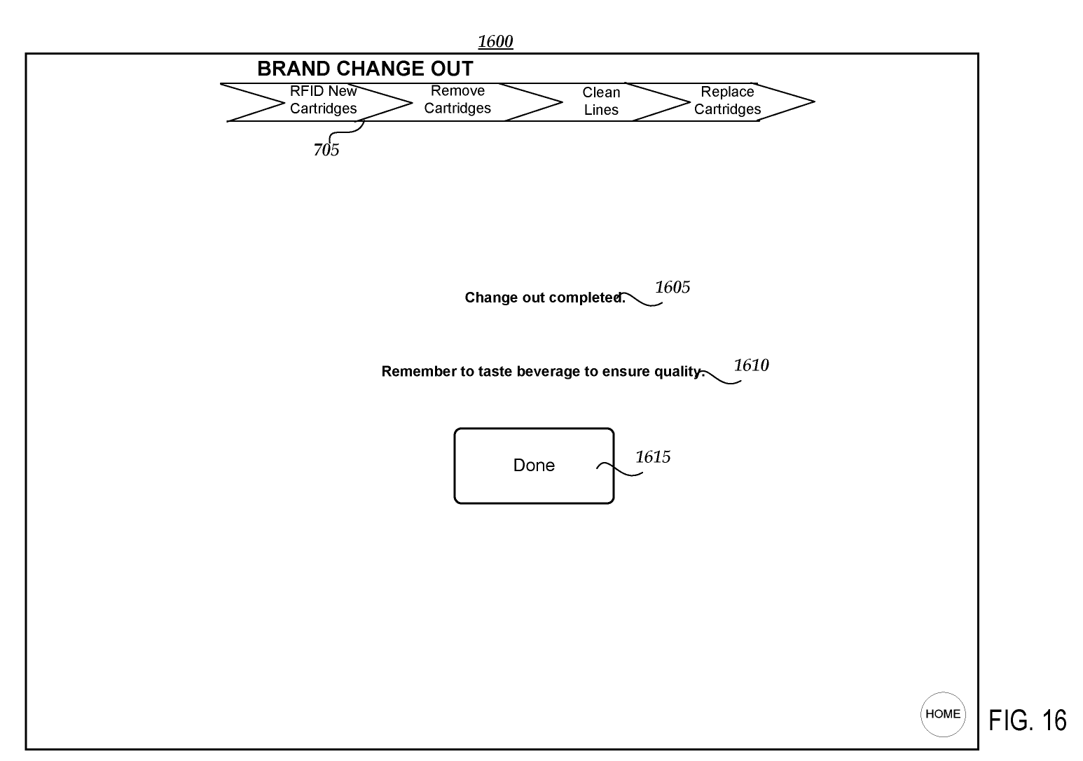

FIG. 16 is a block diagram illustrating a user interface 1600 for updating a dispenser inventory using non-positional awareness, in accordance with an embodiment. The user interface 1600 may display instructions 1605 and 1610 for confirming the priming of the new packaging ingredients and for the customer to taste the beverage produces from the newly installed packaging for quality control. The user interface 1600 may also display a selectable user control 1615 to confirm the completion of the instructions 1605 and 1610 to the dispenser 6.

FIG. 17 is a flow diagram illustrating a routine 1700 for updating a dispenser inventory using non-positional awareness, in accordance with an embodiment. The routine 1700 begins at operation 1705, where the application 22 executing in the dispenser 6, may identify (i.e., by utilizing the interrogator 30) an ingredient packaging to be inserted into the ingredient matrix 25 of the dispenser 6. In some embodiments, the ingredient packaging may be identified by reading an RFID tag (e.g., one of the tags 52A-52N) on the ingredient packaging to identify a beverage product contained in the ingredient packaging. In other embodiments, the ingredient packaging may be identified to contain a cleaning fluid utilized to flush one or more supply lines in the dispenser 6 or a priming fluid utilized to prime one or more supply lines in the dispenser. From operation 1705, the routine 1700 continues to operation 1710, where the application 22 executing on the dispenser 6 may receive a user input of a location within the ingredient matrix 25 where the ingredient packaging (identified at operation 1705) has been inserted. In particular, the application 22 executing on the dispenser 6 may be configured to display a user interface comprising a representation of the ingredient matrix 25, receive a selection of an icon corresponding to the identified ingredient packaging in the user interface, and drag the icon to one of a plurality of slots in the ingredient matrix 25 corresponding to the location where the identified ingredient packaging has been inserted. For example, as described above with respect to FIGS. 7-8, a user (e.g., a customer) may select and drag flushing packaging icons 722 and 724 to vacant dispenser packaging slots 7401 and 740J in a user interface. A selectable user control 805 for initiating the cleaning of the dispenser supply lines associated with the dispenser packaging slots 7401 and 740J may then be displayed. Upon selection of the selectable user control 805, the dispenser 6 may operate one or more pumps to pump cleaning fluid through dispenser plumbing, to a nozzle or other cleaning fluid dispense port (not shown). The text displayed over the dispenser packaging slots 7401 and 740J is also changed to identify the contents (i.e., Cleaning Fluid) of the flushing packaging previously inserted by the customer. As another example, and as described above with respect to FIGS. 11-14, a user may select and drag identified packaging brand icons 1222 and 1224 to vacant dispenser packaging slots 7401 and 740J in a user interface. Thus, it should be understood that a user may drag packaging icons to a location in a virtual representation of the ingredient matrix 25 where the user has physically installed (or will physically install) ingredient packaging in the ingredient matrix 25. From operation 1710, the routine 1700 then ends.

Various embodiments are described above with reference to block diagrams and/or operational illustrations of methods, systems, and computer program products. The operations/acts noted in the blocks may be skipped or occur out of the order as shown in any flow diagram. For example, two or more blocks shown in succession may in fact be executed substantially concurrently or the blocks may sometimes be executed in the reverse order, depending upon the functionality/acts involved.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer-implemented method of determining a position of a tag, comprising:
sending, by an interrogator, a plurality of request signals, each of the plurality of request signals being communicated at a different frequency;
receiving, by the interrogator, a plurality of reply signals from the tag; and
determining a position of the tag along a transmission line from phase measurements of the plurality of reply signals.

2. The method of claim 1, wherein each of the plurality of request signals is communicated along the transmission line.

3. The method of claim 1, wherein the position of the tag is at least one of a relative position and an absolute position along the transmission line.

4. The method of claim 1, wherein the transmission line extends alone one or more dimensions.

5. The method of claim 1, wherein the phase measurements are determined based on a relative magnitude of I and Q channels of the plurality of reply signals.

6. The method of claim 1, wherein each of the plurality of reply signals includes an identification of the tag.

7. The method of claim 1, wherein determining the position of the tag comprises:
determining a phase signature of the tag from the phase measurements; and
correlating the phase signature of the tag to a predetermined phase signature of a location along the transmission line.

8. The method of claim 1, further comprising:
receiving a second plurality of reply signals from another tag; and
determining a position of the other tag along the transmission line from phase measurements of the second plurality of reply signals.

9. The method of claim 8, wherein the position determined for the other tag is distinct from the position determined for the tag.

10. An interrogator comprising:
a memory for storing executable program code; and
a processor, functionally coupled to the memory, the processor being responsive to computer-executable instructions contained in the program code and operative to:
send a plurality of request signals, each of the plurality of request signals being communicated at a different frequency;
receive a plurality of reply signals from a first tag; and
determine a position of the first tag along a transmission line from phase measurements of the plurality of reply signals.

11. The interrogator of claim 10, wherein each of the plurality of request signals is communicated along the transmission line.

12. The interrogator of claim 10, wherein the position of the first tag is at least one of a relative position and an absolute position along the transmission line.

13. The interrogator of claim 10, wherein the transmission line extends alone one or more dimensions.

14. The interrogator of claim 10, wherein the phase measurements are determined based on a relative magnitude of I and Q channels of the plurality of reply signals.

15. The interrogator of claim 10, wherein each of the plurality of reply signals includes an identification of the first tag.

16. The interrogator of claim 10, wherein determining the position of the first tag comprises:
determining a phase signature of the first tag from the phase measurements; and
correlating the phase signature of the first tag to a predetermined phase signature of a location along the transmission line.

17. The interrogator of claim 10, wherein the processor is further operative to:
receive a second plurality of reply signals from a second tag; and
determine a position of the second tag along the transmission line from phase measurements of the second plurality of reply signals, wherein the position of the second tag is distinct from the position of the first tag.

18. A computer-readable storage medium storing computer executable instructions which, when executed by a computing device, will cause the computing device to perform a method of determining a position of a tag, the method comprising:
sending a plurality of request signals, each of the plurality of request signals being communicated at a different frequency;
receiving a plurality of reply signals from the tag; and
determining a position of the tag along a transmission line from phase measurements of the plurality of reply signals.

19. The computer-readable storage medium of claim 18, wherein each of the plurality of request signals is communicated along the transmission line.

20. The computer-readable storage medium of claim 18, wherein the position of the tag is at least one of a relative position and an absolute position along the transmission line.

21. The computer-readable storage medium of claim 18, wherein the transmission line extends alone one or more dimensions.

22. The computer-readable storage medium of claim 18, wherein the phase measurements are determined based on a relative magnitude of I and Q channels of the plurality of reply signals.

23. The computer-readable storage medium of claim 18, wherein each of the plurality of reply signals includes an identification of the tag.

24. The computer-readable storage medium of claim 18, wherein determining the position of the tag comprises:
determining a phase signature of the tag from the phase measurements; and
correlating the phase signature of the tag to a predetermined phase signature of a location along the transmission line.

25. The computer-readable storage medium of claim 18, further comprising:
receiving a second plurality of reply signals from another tag; and
determining a position of the other tag along the transmission line from phase measurements of the second plurality of reply signals.

26. The computer-readable storage medium of claim 25, wherein the position determined for the other tag is distinct from the position determined for the tag.

27. A computer-implemented method of managing a dispenser inventory, comprising:
identifying an ingredient packaging to be inserted into an ingredient matrix of a dispenser; and
receiving a user input of a location within the ingredient matrix where the identified ingredient packaging has been inserted.

28. The method of claim 27, wherein identifying an ingredient packaging to be inserted into an ingredient matrix of a dispenser comprises reading a tag on the ingredient packaging to identify a beverage product contained in the ingredient packaging.

29. The method of claim 27, wherein identifying an ingredient packaging to be inserted into an ingredient matrix of a dispenser comprises reading a tag on the ingredient packaging to identify a cleaning fluid, the cleaning fluid being utilized to flush one or more supply lines in the dispenser.

30. The method of claim 27, wherein identifying an ingredient packaging to be inserted into an ingredient matrix of a dispenser comprises reading a tag on the ingredient packaging to identify a priming fluid, the priming fluid being utilized to prime one or more supply lines in the dispenser.

31. The method of claim 27, wherein receiving a user input of a location within the ingredient matrix where the identified ingredient packaging has been inserted comprises:
displaying a user interface comprising a representation of the ingredient matrix;
receiving a selection of an icon corresponding to the identified ingredient packaging in the user interface; and
dragging the icon to one of a plurality of slots in the ingredient matrix corresponding to the location where the identified ingredient packaging has been inserted.

32. A dispenser comprising:
a memory for storing executable program code; and
a processor, functionally coupled to the memory, the processor being responsive to computer-executable instructions contained in the program code and operative to:
identify an ingredient packaging to be inserted into an ingredient matrix; and
receive a user input of a location within the ingredient matrix where the identified
ingredient packaging has been inserted.

33. The dispenser of claim 32, wherein the processor, in identifying an ingredient packaging to be inserted into an ingredient matrix, is operative to read a tag on the ingredient packaging to identify a beverage product contained in the ingredient packaging.

34. The dispenser of claim 32, wherein the processor, in identifying an ingredient packaging to be inserted into an ingredient matrix, is operative to read a tag on the ingredient packaging to identify a cleaning fluid, the cleaning fluid being utilized to flush one or more dispenser supply lines.

35. The dispenser of claim 32, wherein the processor, in identifying an ingredient packaging to be inserted into an ingredient matrix, is operative to read a tag on the ingredient packaging to identify a priming fluid, the priming fluid being utilized to prime one or more dispenser supply lines.

36. The dispenser of claim 32, wherein the processor, in receiving a user input of a location within the ingredient matrix where the identified ingredient packaging has been inserted, is operative to:
display a user interface comprising a representation of the ingredient matrix;
receive a selection of an icon corresponding to the identified ingredient packaging in the user interface; and
drag the icon to one of a plurality of slots in the ingredient matrix corresponding to the location where the identified ingredient packaging has been inserted.

37. A computer-readable storage medium storing computer executable instructions which, when executed by a computing device, will cause the computing device to perform a method of managing a dispenser inventory, the method comprising:
identifying an ingredient packaging to be inserted into an ingredient matrix of a dispenser; and
receiving a user input of a location within the ingredient matrix where the identified ingredient packaging has been inserted.

38. The computer-readable storage medium of claim 37, wherein identifying an ingredient packaging to be inserted into an ingredient matrix of a dispenser comprises reading a tag on the ingredient packaging to identify a beverage product contained in the ingredient packaging.

39. The computer-readable storage medium of claim 37, wherein identifying an ingredient packaging to be inserted into an ingredient matrix of a dispenser comprises reading a tag on the ingredient packaging to identify a cleaning fluid, the cleaning fluid being utilized to flush one or more supply lines in the dispenser.

40. The computer-readable storage medium of claim 37, wherein identifying an ingredient packaging to be inserted into an ingredient matrix of a dispenser comprises reading a tag on the ingredient packaging to identify a priming fluid, the priming fluid being utilized to prime one or more supply lines in the dispenser.

41. The computer-readable storage medium of claim 37, wherein receiving a user input of a location within the ingredient matrix where the identified ingredient packaging has been inserted comprises:
displaying a user interface comprising a representation of the ingredient matrix;
receiving a selection of an icon corresponding to the identified ingredient packaging in the user interface; and
dragging the icon to one of a plurality of slots in the ingredient matrix corresponding to the location where the identified ingredient packaging has been inserted.
